(19) United States
(12) Patent Application Publication
(10) Pub. No.: US 2026/0121548 A1
(43) Pub. Date: Apr. 30, 2026

(54) MULTI-OUTPUT SWITCHING POWER SUPPLY AND A CONTROL METHOD THEREOF

(71) Applicant: Joulwatt Technology Co., Ltd., Hangzhou City (CN)

(72) Inventors: Anyang ZHANG, Hangzhou (CN); Junming ZHANG, Hangzhou (CN); Delai JIANG, Hangzhou (CN); Xiangyong XU, Hangzhou (CN)

(21) Appl. No.: 19/365,350

(22) Filed: Oct. 22, 2025

(30) Foreign Application Priority Data
Oct. 31, 2024 (CN) 202411548594.X

(51) Int. Cl. H02M 3/335; H02M 1/00; H02M 1/08; H02M 1/32

(52) U.S. Cl. CPC H02M 3/33592; H02M 1/0083; H02M 1/08; H02M 1/32

(57) ABSTRACT

A multi-output switching power supply and a control method thereof are provided. The multi-output switching power supply comprises: a power conversion module performing power conversion on an input signal according to a drive signal to obtain a first output signal; a power distribution module converting the first output signal into plurality of output signals according to a plurality of distribution signals; a control circuit generating the drive signal based on feedback of the output signal from the first power distribution unit, and generating a plurality of distribution signals based on feedback of output signals from other power distribution units. Each power distribution unit comprises a first transistor and a second transistor connected back-to-back, with each distribution signal controlling switching states of corresponding first transistor and second transistor. The present disclosure can improve work efficiency of the multi-output switching power supply, reduce heat generation during operation, and lower system costs.

### CROSS-REFERENCE TO RELATED APPLICATIONS

This present disclosure claims priority to a Chinese patent application No. 202411548594.X, filed on October 31, 2024, and entitled "MULTI-OUTPUT SWITCHING POWER SUPPLY AND A CONTROL METHOD THEREOF", the entire contents of which are incorporated herein by reference, comprising the specification, claims, drawings and abstract.

### FIELD OF TECHNOLOGY

The present disclosure relates to a field of charger technology, particularly, to a multi-output switching power supply and a control method thereof.

### BACKGROUND

A charger is a device that converts alternating current into low-voltage direct current. With the development of fast charging technology and the widespread application of mobile phone peripherals, there are more and more dual-port or multi-port chargers on the market, and the demand for fast charging functions on one of the output ports of multi-port chargers is increasing.

At present, most dual-port or multi-port chargers with fast charging functions on the market are either two independent circuits or secondary DC-DC converters to meet the different voltage requirements for fast charging and normal charging, which leads to an increase in the size of the charger and an increase in the number of components, resulting in increased costs.

### SUMMARY OF THE DISCLOSURE

To solve the above technical problems, the present disclosure provides a multi-output switching power supply and a control method thereof, aiming to improve the output efficiency of the multi-output switching power supply, reduce heat generation during operation, and reduce system costs.

According to a first aspect of the present disclosure, a multi-output switching power supply is provided and comprises:

a power conversion module, configured to perform power conversion on an input signal of the multi-output switching power supply according to a drive signal to obtain a first output signal;

a plurality of power distribution units, coupled between an output terminal of the power conversion module and a plurality of output terminals of the multi-output switching power supply, respectively, and configured to convert the first output signal into a plurality of output signals according to a plurality of distribution signals, the plurality of output signals being output from the plurality of output terminals respectively; and

a control circuit, configured to generate the drive signal according to feedback of an output signal of a first power distribution unit among the plurality of power distribution units, and generate the plurality of distribution signals according to feedback of output signals of other power distribution units among the plurality of power distribution units,

wherein each of power distribution units comprises a first transistor and a second transistor connected back-to-back, and each of the distribution signals is configured to control switching states of the first transistor and the second transistor of a corresponding power distribution unit.

Optionally, the first transistor and the second transistor are low-voltage transistors.

Optionally, the first transistor and the second transistor are switching transistors; a cathode of a body diode of the first transistor is coupled to the output terminal of the power conversion module, and a cathode of a body diode of the second transistor is coupled to a corresponding output terminal of the plurality of output terminals;

the distribution signals of each of the power distribution units comprises a first distribution signal and a second distribution signal, a control terminal of the first transistor receives the first distribution signal of the distribution signals of the corresponding power distribution unit, and a control terminal of the second transistor receives the second distribution signal of the distribution signals of the corresponding power distribution unit.

Optionally, the first transistor is a switching transistor, and the second transistor is a diode; a cathode of a body diode of the first transistor is coupled to the output terminal of the power conversion module, an anode of the diode is coupled to an anode of the body diode of the first transistor, and a cathode of the diode is coupled to a corresponding output terminal of the plurality of output terminals; a control terminal of the first transistor receives the distribution signal of the corresponding power distribution unit.

Optionally, the plurality of distribution signals are configured to: control the first transistor of each of the power distribution units to be turned on alternately; control the second transistor of each of the power distribution units to be turned on or to be continuously turned off during a period when the first transistor of the corresponding power distribution unit is turned on; wherein a magnitude of an output signal of each of the power distribution units is positively correlated with a turn-on duration of the first transistor of the power distribution unit.

Optionally, the plurality of distribution signals are further configured to:

control the first transistor of each of the power distribution units to be turned on alternately;

wherein a magnitude of an output signal of each of the power distribution units is positively correlated with a turn-on duration of the first transistor of the power distribution unit.

Optionally, a dead time is between the conducting first transistor of each of the power distribution unit and the adjacent conducting second transistor of a next power distribution unit that is turned on.

Optionally, an overlapping conduction time is between two adjacent conducting first transistors of the two power distribution units .

Optionally, the plurality of power distribution units comprise the first power distribution unit and a second power distribution unit; the control circuit comprises a distribution control module and a drive control module;

the distribution control module is configured to generate a first error regulation signal according to feedback of an output signal of the first power distribution unit and transmit the first error regulation signal to the drive control module, and the drive control module is configured to generate the drive signal according to the first error regulation signal to control a switching state of a main power transistor of the power conversion module;

the distribution control module is further configured to generate a second error regulation signal according to feedback of an output signal of the second power distribution unit, generate a first conduction time indication signal according to the second error regulation signal, and perform a logic operation on the first conduction time indication signal, a turn-on indication signal of the main power transistor, and a turn-off indication signal of the main power transistor to generate the plurality of distribution signals to control switching states of transistors of the plurality of power distribution units;

the first conduction time indication signal is configured to indicate that an expected turn-on time time of the first transistor of the second power distribution unit after turn-off of the main power transistor is a first conduction time, and a magnitude of the first conduction time is controlled according to the second error regulation signal.

Optionally, the distribution control module is configured to: turn on the first transistor of the second power distribution unit during a period when the main power transistor is turned on;

turn off the first transistor of the first power distribution unit after the first transistor of the second power distribution unit is turned on for the overlapping conduction time;

turn on the first transistor of the first power distribution unit after a first time following turn-off of the main power transistor; and

turn off the first transistor of the second power distribution unit after a second time following turn-off of the main power transistor, wherein the second time is greater than the first time.

Optionally, in a case of the first conduction time being greater than a preset first time threshold and less than a preset second time threshold, the distribution control module is further configured to:

turn on the second transistor of the second power distribution unit for a third time after turn-off of the main power transistor and before turn-off of the first transistor of the second power distribution unit; and

turn on the second transistor of the first power distribution unit for a fourth time after turn-off of the first transistor of the second power distribution unit and before turn-off of the first transistor of the first power distribution unit, wherein the first time threshold is equal to a sum of a preset minimum conduction time threshold and a dead time, and the second time threshold is a preset maximum conduction time threshold.

Furthermore, the first time is equal to the first conduction time minus the overlap conduction time; the second time is equal to the first conduction time; the third time is equal to the first conduction time minus the overlapping conduction time and then subtracting the dead time;

the fourth time is equal to a time between a turn off time of the first transistor in the second power distribution unit and the first time minus the dead time, wherein the first time represents a time when a drain voltage of the second transistor in the first power distribution unit is greater than a drain voltage of the first transistor in the first power distribution unit.

Optionally, in a case of the first conduction time being greater than or equal to a preset second time threshold, the distribution control module is further configured to: turn on the second transistor of the second power distribution unit for a third time after turn-off of the main power transistor and before turn-off of the first transistor of the second power distribution unit; and control the second transistor of the first power distribution unit to be continuously turned off, wherein the second time threshold is a preset maximum conduction time threshold.

Furthermore, the first time is equal to a sum of the third time and the dead time;

the second time is equal to a sum of the third time, the dead time, and the overlapping conduction time; the third time is equal to a time between a turn off time of the main power transistor and the second time, wherein the second time represents a time when a drain voltage of the second transistor in the second power distribution unit is greater than a drain voltage of the first transistor in the second power distribution unit.

Optionally, in a case of the first conduction time being less than or equal to the preset first time threshold, the distribution control module is further configured to: control the second transistor of the second power distribution unit to be continuously turned off; and

turn on the second transistor of the first power distribution unit for a fourth time after turn-off of the first transistor of the second power distribution unit and before turn-off of the first transistor of the first power distribution unit,

wherein the first time threshold is equal to a sum of a preset minimum conduction time threshold and a dead time.

Furthermore, the first time is equal to zero;

the second time is equal to the overlapping conduction time;

the fourth time is equal to a time between a turn off time of the first transistor in the second power distribution unit and the first time minus the dead time, wherein the first time represents a time when a drain voltage of the second transistor in the first power distribution unit is greater than a drain voltage of the first transistor in the first power distribution unit.

Optionally, the plurality of power distribution units comprise the first power distribution unit, a second power distribution unit, and a third power distribution unit;

the control circuit comprises a distribution control module and a drive control module;

the distribution control module is configured to generate a first error regulation signal according to feedback of an output signal of the first power distribution unit and transmit the first error regulation signal to the drive control module, and the drive control module is configured to generate the drive signal according to the first error regulation signal to control a switching state of a main power transistor of the power conversion module;

the distribution control module is further configured to generate a second error regulation signal according to feedback of an output signal of the second power distribution unit, generate a third error regulation signal according to feedback of an output signal of the third power distribution unit, and generate three distribution signals according to the second error regulation signal and the third error regulation signal to control switching states of transistors of the first power distribution unit, the second power distribution unit, and the third power distribution unit respectively.

Optionally, the multi-output switching power supply further comprises:

a voltage overshoot protection unit coupled to the output terminal of the power conversion module and configured to control the first output signal within a preset range during startup of the multi-output switching power supply.

Optionally, the multi-output switching power supply further comprises:

a switch connection path between an output terminal of each power distribution unit and a corresponding load connection terminal, and configured to be turned on when a load device is connected to the corresponding output terminal.

Optionally, the power conversion module comprises a main power transistor, a rectifier transistor, and a transformer;

the main power transistor is connected to a primary winding of the transformer, the rectifier transistor is connected to a secondary winding of the transformer, and a voltage on the secondary winding of the transformer is rectified by the rectifier transistor to obtain the first output signal;

the main power transistor and the rectifier transistor are high-voltage transistors.

Optionally, the rectifier transistor is connected between the secondary winding and a ground terminal.

According to a second aspect of the present disclosure, a control method for a multi-output switching power supply is provided, the multi-output switching power supply comprises a plurality of power distribution units, and the control method comprises:

generating a drive signal according to feedback of an output signal of a first power distribution unit among the plurality of power distribution units, and generating a plurality of distribution signals according to feedback of output signals of other power distribution units among the plurality of power distribution units;

performing power conversion on an input signal of the multi-output switching power supply according to the drive signal to obtain a first output signal; and

converting the first output signal into a plurality of output signals according to the plurality of distribution signals controlling the plurality of power distribution units, the plurality of output signals being output from the plurality of output terminals respectively,

wherein each of power distribution units comprises a first transistor and a second transistor connected back-to-back, and each of distribution signals is configured to control switching states of the first transistor and the second transistor of a corresponding power distribution unit.

Advantages of the present disclosure at least comprise:

In a multi-output operating mode of the multi-output switching power supply, the embodiments of the present disclosure regulate the total system power through the feedback of the output signal of the first power distribution unit among the plurality of power distribution units, and control the power allocation among the multi-channel output terminals through the feedback of the output signals of the other power distribution units. Compared with existing solutions, the multi-output switching power supply provided by the present disclosure needs only one power-conversion module, and uses two low-voltage transistors (the first transistor and the second transistor) connected back-to-back as the power distribution unit. Consequently, no additional power-conversion modules and no inductive components are required during power allocation, so that system efficiency is raised, heating during operation is reduced, and system cost is lowered. Moreover, since the first transistor and the second transistor connected back-to-back afford higher secondary-conversion efficiency of the total system power, larger output power can also be achieved.

In further specific examples, since the body diodes of the first transistor and the second transistor are connected in opposite directions, no circulating current can arise among different output channels, so that the various outputs can be controlled independently.

It should be understood that the foregoing general description and the subsequent detailed description are merely exemplary and explanatory, and are not intended to limit the present disclosure.

### BRIEF DESCRIPTION OF THE DRAWINGS

FIG. 1 is a block diagram showing the structure of a multi-output switching power supply provided by an embodiment of the present disclosure;

FIG. 2 is a schematic diagram illustrating the implementation of the multi-output switching power supply according to a first embodiment of the present disclosure;

FIG. 3 is a schematic diagram illustrating the implementation of the multi-output switching power supply according to a second embodiment of the present disclosure;

FIG. 4 is a schematic diagram illustrating the implementation of a control circuit provided by an embodiment of the present disclosure;

FIG. 5 is a timing waveform diagram showing control signals of transistors in a multi-output switching power supply with two outputs provided by an embodiment of the present disclosure;

FIG. 6 is a timing waveform diagram showing voltages at some nodes and output currents in the multi-output switching power supply with two outputs provided by an embodiment of the present disclosure;

FIG. 7 is a timing waveform diagram showing control signals of transistors in a multi-output switching power supply with three outputs provided by an embodiment of the present disclosure;

FIG. 8 is a timing waveform diagram showing voltages at some nodes and output currents in the multi-output switching power supply with three outputs provided by an embodiment of the present disclosure;

FIG. 9 is a flow diagram illustrating a control method for the multi-output switching power supply provided by an embodiment of the present disclosure.

### DETAILED DESCRIPTION OF THE DISCLOSURE

To facilitate understanding of the present disclosure, the following gives a more comprehensive description of the present disclosure with reference to the related drawings. The accompanying drawings show specific embodiments of the present disclosure. However, the present disclosure may be implemented in many different forms and is not limited to the embodiments described herein. On the contrary, these embodiments are provided so that the disclosure of the present disclosure will be more thorough and complete.

In the present specification, references to “one embodiment,” “some embodiments,” “other embodiments,” or “further embodiments” and the like mean that specific features, structures, or characteristics described in connection with the embodiment are comprised in one or more embodiments of the present disclosure. Thus, the appearances of the phrases “in one embodiment,” “in some embodiments,” “in other embodiments,” etc. in various places throughout this specification are not necessarily all referring to the same embodiment, but mean “one or more but not all embodiments,” unless otherwise expressly specified. The terms “comprising,” “comprising,” “having,” and variations thereof mean “comprising but not limited to,” unless otherwise expressly specified.

In the description of the present disclosure, “exemplary” or “for example” and the like are used to indicate serving as an example, illustration, or description. Any embodiment described herein as “exemplary” or “for example” is not to be construed as necessarily more specific or advantageous than other embodiments. “And/or” is a description of an associated relationship of associated objects, indicating that there may be three relationships, for example, A and/or B may indicate: A alone exists, A and B exist at the same time, and B alone exists. “A plurality” means two or more than two. In addition, to clearly describe the technical solutions of the embodiments of the present disclosure, words such as “first,” “second,” and the like are used to distinguish items that are substantially the same or have substantially the same function or effect. Those skilled in the art can understand that the words “first,” “second,” and the like do not limit the quantity and execution order, and do not necessarily indicate that the items are different. “Coupled” is a description of a connection relationship between associated objects; for example, A is coupled to B may indicate that A and B are directly connected, or that A and B are indirectly connected through another device/unit/module.

The transistor referred to herein generally refers to any single component based on semiconductor materials, comprising diodes, triodes, field-effect transistors, thyristors, and the like made of various semiconductor materials.

The “back-to-back connection” described herein refers to a connection manner in which the anodes of the body diodes of two transistors are connected to each other, so that the cathode ends of the body diodes serve as signal input/output ends.

In addition, the same reference numerals in the drawings denote the same or similar structures, and thus repeated descriptions thereof will be omitted. That is, in the present specification, each part is described in a parallel and progressive manner, with emphasis on the differences from other parts, and the same or similar parts in each part may be cross-referenced.

In the related art, the implementation schemes of a multi-output switching power supply (taking a dual-output switching power supply as an example) comprise the following:

Scheme 1: An AC/DC module is used for input energy conversion, and a plurality of buck circuits are arranged at the output rear stage of the AC/DC module to achieve multi-output terminals, each output terminal corresponding to one buck circuit;

Scheme 2: An AC/DC module is used for input energy conversion, its output directly serves as the output of one output terminal, and the output of the other output terminal is achieved by arranging a buck-boost circuit at the output rear stage of the AC/DC module;

Scheme 3: Two independent AC/DC modules are provided to perform input energy conversion respectively, and the outputs of the two AC/DC modules are used as the outputs of the two output terminals, etc.

Among them, the disadvantage of Scheme 1 is that each output terminal needs to be provided with a corresponding buck circuit, and a buck circuit generally comprises two switching transistors, an inductor, and a control circuit, resulting in high system cost, low efficiency of the buck circuit, severe heating, and affecting user experience.

The disadvantage of Scheme 2 is that one output terminal needs to be provided with a buck-boost circuit, and a buck-boost circuit generally comprises four switching transistors, an inductor, and a control circuit, resulting in high system cost, low charging efficiency of the output terminal provided with the buck-boost circuit, severe heating, and inability to output large power.

The disadvantage of Scheme 3 is that each output terminal corresponds to an AC/DC circuit, and each AC/DC circuit generally comprises a transformer, a primary-side switch, a primary-side control circuit, an optocoupler, a secondary-side diode, and a secondary-side control circuit, resulting in very high system cost.

The embodiments of the present disclosure provide a new multi-output switching power supply, which mainly uses two low-voltage transistors (a first transistor and a second transistor) connected back-to-back as a power distribution unit to achieve multiple outputs, so that no inductor component is needed in the power distribution process, and larger power output can be achieved. Therefore, the multi-output switching power supply provided by the embodiments of the present disclosure can greatly improve the working efficiency of the multi-output switching power supply, and has low heating and low system cost during operation.

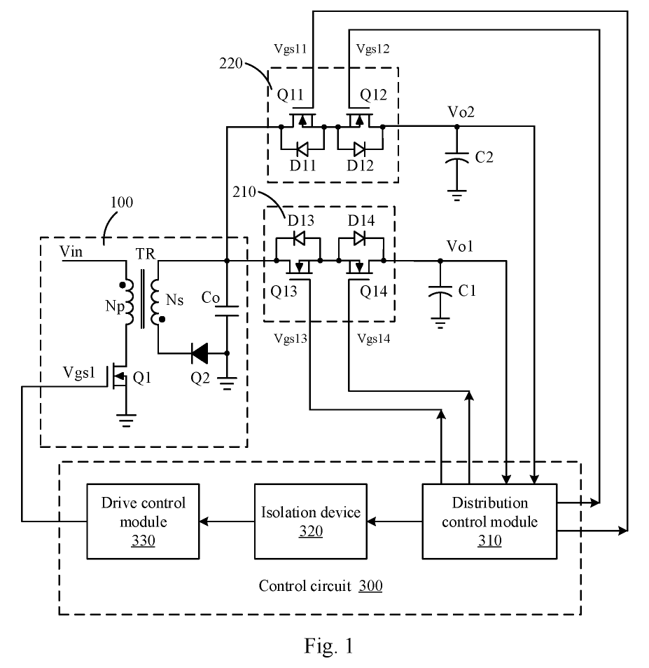

Referring to FIGS. 1,2, and 3, the multi-output switching power supply provided by the embodiments of the present disclosure comprises: a power conversion module 100, a plurality of power distribution units, and a control circuit 300. The power conversion module 100 receives an input signal, the plurality of power distribution units is coupled between an output terminal of the power conversion module 100 and multi-channel output terminals of the multi-output switching power supply, and the control circuit 300 is coupled to the power conversion module 100 and the plurality of power distribution units, respectively.

The power conversion module 100 performs power conversion on the input signal of the multi-output switching power supply according to a drive signal Vgs1 to obtain a first output signal. Optionally, the input signal Vin described herein comprises at least one of an input voltage and an input current. Similarly, the output signal comprises at least one of an output voltage and an output current. For ease of understanding, hereinafter, only voltage signals will be used to represent the input signal and the output signal as examples.

The plurality of power distribution units is configured to, according to plurality of distribution signals, convert the first output signal output by the power conversion module 100 into a plurality of output signals and distribute them to a plurality of output terminals. Each power distribution unit comprises a first transistor and a second transistor connected back-to-back, and each distribution signal is used to control the switching states of the first transistor and the second transistor of the corresponding power distribution unit.

Optionally, the plurality of output terminals include but are not limited to at least one of common output terminals such as Type-A interfaces and Type-C interfaces.

The control circuit 300 is configured to generate the drive signal Vgs1 according to feedback of an output signal (such as an output voltage or an output current) of the first power distribution unit among the plurality of power distribution units, and output it to the power conversion module 100, and generate the plurality of distribution signals according to feedback of output signals (such as output voltages or output currents) of other power distribution units among the plurality of power distribution units, and output them to the plurality of power distribution units.

Optionally, in some examples, the control circuit 300 uses a fixed one of the plurality of power distribution units as the first power distribution unit; in other examples, the control circuit 300 may also compare the output power of each power distribution unit, and use the power distribution unit with the largest output power as the first power distribution unit.

In some examples, the control circuit 300 is further configured to, in a single-output mode, generate the drive signal Vgs1 output to the power conversion module 100 according to feedbcak of the output terminal connected to a load device.

Hereinafter, a multi-output switching power supply with two output terminals is taken as an example to describe the solution of the present disclosure in detail. However, it should be understood that the solution of the present disclosure may also be applied to a multi-output switching power supply with three or more output terminals, as long as it conforms to the basic inventive concept of the present disclosure (i.e., two transistors connected back-to-back are used for power distribution on the output path corresponding to each output interface).

During specific implementation, the input signal received by the power conversion module 100 may be a DC signal or an AC signal. The circuit topology of the power conversion module 100 may be any isolated topology (such as forward, flyback, push-pull, etc.) or non-isolated topology (such as Buck, Boost, Buck-Boost, etc.) that can achieve power conversion.

In the examples shown in FIGS. 1,2, and 3, the power conversion module 100 comprises: a transformer TR having a primary winding Np and a secondary winding Ns, a main power transistor Q1 located on the primary side of the transformer TR and coupled to the primary winding Np, and a rectifier transistor Q2 and an output capacitor Co located on the secondary side of the transformer TR and coupled to the secondary winding Ns. The control terminal of the main power transistor Q1 receives the drive signal Vgs1, and is used to perform power conversion on the input signal Vin of the multi-output switching power supply according to the drive signal Vgs1, and the voltage on the secondary winding Ns of the transformer TR is rectified by the rectifier transistor Q2 to obtain the first output signal.

The main power transistor Q1 and the rectifier transistor Q2 are both high-voltage transistors. Optionally, for example, the main power transistor Q1 is an NMOS field-effect transistor, and the rectifier transistor Q2 may be a diode or a synchronous rectifier switching transistor. When the rectifier transistor Q2 is a synchronous rectifier switching transistor, the power conversion module 100 further comprises a synchronous rectifier control circuit (not shown in the figures) that provides a control signal to the rectifier transistor Q2.

It should be noted that, for simplicity of the drawings, only the main part of the power conversion module 100 is shown in FIGS. 1,2, and 3. The specific structure of the power conversion module 100 may be understood with reference to related existing solutions.

Each power distribution unit comprises two low-voltage transistors connected back-to-back, i.e., a first transistor and a second transistor. It should be noted that the high-voltage transistors and low-voltage transistors described herein are relative concepts. For example, the main power transistor Q1 and the rectifier transistor Q2 are high-voltage transistors relative to the first transistor and the second transistor in each power distribution unit, while the first transistor and the second transistor are low-voltage transistors relative to the main power transistor Q1 and the rectifier transistor Q2.

In some examples, the first transistor and the second transistor are switching transistors. In this case, the first transistor and the second transistor are connected in series between the output terminal of the power conversion module 100 and the corresponding output terminal among the multi-channel output terminals of the multi-output switching power supply. The cathode of the body diode of the first transistor is coupled to the output terminal of the power conversion module 100, and the cathode of the body diode of the second transistor is coupled to the corresponding output terminal among the multi-channel output terminals. Correspondingly, the distribution signal of each power distribution unit comprises a first distribution signal and a second distribution signal. The control terminal of the first transistor receives the first distribution signal of the distribution signal of the corresponding power distribution unit, and the control terminal of the second transistor receives the second distribution signal of the distribution signal of the corresponding power distribution unit.

In other examples, the first transistor is a switching transistor, and the second transistor is a diode. In this case, the first transistor and the second transistor are cascade-coupled between the output terminal of the power conversion module 100 and the corresponding output terminal among a plurality of output terminals of the multi-output switching power supply. The cathode of the body diode of the first transistor is coupled to the output terminal of the power conversion module 100, the anode of the diode (second transistor) is coupled to the anode of the body diode of the first transistor, and the cathode of the diode (second transistor) is coupled to the corresponding output terminal among the plurality of output terminals. Correspondingly, the control terminal of the first transistor receives the distribution signal of the corresponding path.

When the first transistor and the second transistor are switching transistors, the plurality of distribution signals output by the control circuit 300 are used to achieve alternate conduction of the first transistor in each power distribution unit, and to control the second transistor in each power distribution unit to be turned on or continuously turned off during the conduction period of the first transistor of the corresponding power distribution unit being turned on.

When the first transistor is a switching transistor and the second transistor is a diode, the plurality of distribution signals output by the control circuit 300 only need to control the alternate conduction of the first transistor in each power distribution unit.

Furthermore, the magnitude of the output signal of each power distribution unit is positively correlated with the conduction duration of the first transistor in that power distribution unit.

In some specific examples, the control circuit 300 is further configured to set a dead time between the conducting first transistor of each power distribution unit and the adjacent conducting second transistor of the next power distribution unit . In this way, circulating current between the first power distribution unit 210 and the second power distribution unit 220 can be avoided during regulated output.

In some specific examples, the control circuit 300 is further configured to set an overlapping conduction time between the two adjacent conducting first transistors of two power distribution units. In this way, voltage overshoot at node A can be avoided during regulated output.

Referring to FIGS. 1, 2 and 3, the working principle of the multi-output switching power supply is explained below by taking the plurality of power distribution units comprising the first power distribution unit 210 and the second power distribution unit 220, and the first transistor and the second transistor in each power distribution unit being switching transistors as an example.

For ease of distinction, the first transistor and the second transistor in the second power distribution unit 220 are respectively denoted as transistor Q11 and transistor Q12, and the first transistor and the second transistor in the first power distribution unit 210 are respectively denoted as transistor Q13 and transistor Q14. In other words, transistor Q11 corresponds to the first transistor in the second power distribution unit 220, transistor Q12 corresponds to the second transistor in the second power distribution unit 220, transistor Q13 corresponds to the first transistor in the first power distribution unit 210, and transistor Q14 corresponds to the second transistor in the first power distribution unit 210. The control terminal of transistor Q11 receives the distribution signal Vgs11, the control terminal of transistor Q12 receives the distribution signal Vgs12, the control terminal of transistor Q13 receives the distribution signal Vgs13, and the control terminal of transistor Q14 receives the distribution signal Vgs14.

By way of example, assuming that transistors Q11, Q12, Q13 and Q14 are all NMOS field-effect transistors, their respective body diodes can be denoted as D11, D12, D13 and D14. The cathode of the body diode of the first transistor corresponds to the drain of the NMOS field-effect transistor, the anode of the body diode of the first transistor corresponds to the source of the NMOS field-effect transistor, the anode of the body diode of the second transistor corresponds to the source of the NMOS field-effect transistor, and the cathode of the body diode of the second transistor corresponds to the drain of the NMOS field-effect transistor. Of course, in other embodiments of the present disclosure, transistors Q11, Q12, Q13 and Q14 may also be wholly or partially PMOS field-effect transistors or other types of transistors.

In this embodiment, the control circuit 300 comprises: a distribution control module 310 and a drive control module 330.

When the multi-output switching power supply has two output terminals, that is, the plurality of power distribution units comprise the first power distribution unit 210 and the second power distribution unit 220, the distribution control module 310 is used to generate a first error regulation signal based on the feedback of the output signal (such as output voltage Vo1 or output current Io1) of the first power distribution unit 210 and transmit it to the drive control module 330. The drive control module 330 then generates the drive signal Vgs1 based on the first error regulation signal to control the switching state of the main power transistor Q1 in the power conversion module 100. At the same time, the distribution control module 310 is also used to generate a second error regulation signal based on the feedback of the output signal (such as output voltage Vo2 or output current Io2) of the second power distribution unit 220, generate a first conduction time indication signal based on the second error regulation signal, and perform logic operations on the first conduction time indication signal, the turn-on indication signal of the main power transistor and the turn-off indication signal of the main power transistor to generate plurality of distribution signals to control the switching states of the transistors in the plurality of power distribution units. The first conduction time indication signal is used to indicate that the expected conduction time of the first transistor (transistor Q11) in the second power distribution unit 220 in the current control cycle is the first conduction time (denoted as ton), that is, the expected conduction time of transistor Q11 after the main power transistor Q1 is turned off. The magnitude of the first conduction time is controlled based on the second error regulation signal. The turn-on indication signal of the main power transistor represents the turn-on moment of the main power transistor Q1, and the turn-off indication signal of the main power transistor represents the turn-off moment of the main power transistor Q1.

In some examples, the distribution control module 310 transmits the first error regulation signal to the drive control module 330 through an isolation device 320. For example, when the power conversion module 100 is of an isolated topology, the distribution control module 310 is located on the secondary side of the power conversion module 100, and the drive control module 330 is located on the primary side of the power conversion module 100, and the two communicate through the isolation device 320. The specific structure of the drive control module 330 can be understood with reference to related existing solutions, and will not be described in detail here.

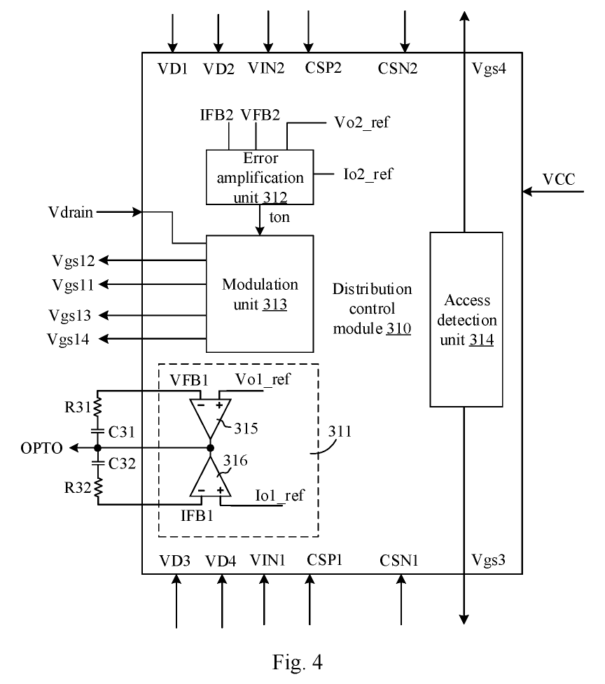

Further, referring to FIG. 4, the distribution control module 310 specifically comprises: a first error amplification unit 311, a second error amplification unit 312, a modulation unit 313 and an access detection unit 314.

The first error amplification unit 311 is used to perform error amplification on the feedback signal VFB1 of the output voltage of the first power distribution unit 210 and the first reference voltage signal Vo1_ref, or to perform error amplification on the feedback signal IFB1 of the output current of the first power distribution unit 210 and the first reference current signal Io1_ref, to generate the first error regulation signal, and transmit it to the drive control module 330 through the isolation device 320.

In some examples, the first error amplification unit 311 comprises, for example, an error amplifier 315 and an error amplifier 316. The first input terminal of the error amplifier 315 receives the feedback signal VFB1, the second input terminal of the error amplifier 315 receives the first reference voltage signal Vo1_ref, the first input terminal of the error amplifier 316 receives the feedback signal IFB1, the second input terminal of the error amplifier 316 receives the first reference current signal Io1_ref, and the output terminals of the error amplifier 315 and the error amplifier 316 are coupled. Further, a resistor R31 and a capacitor C31 are also coupled in series between the first input terminal and the output terminal of the error amplifier 315, and a resistor R32 and a capacitor C32 are coupled in series between the first input terminal and the output terminal of the error amplifier 316. The first error amplification unit 311 outputs the first error regulation signal through the error amplifier 315 and the error amplifier 316.

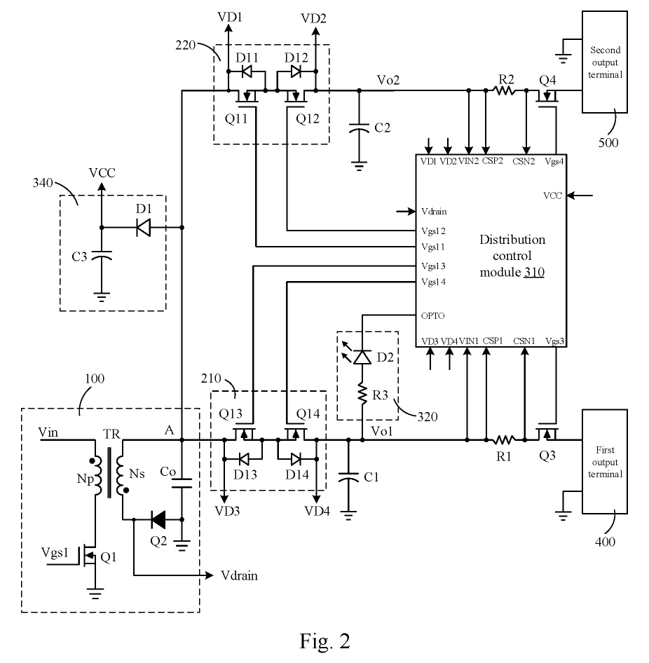

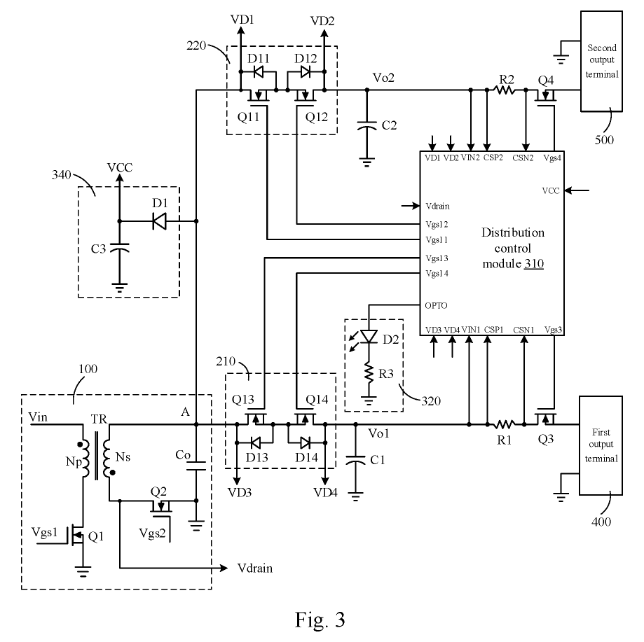

Taking the isolation device 320 as an opto-isolation device as an example, as shown in FIGS. 2 and 3, the isolation device 320 comprises an opto-coupler diode D2 and a resistor R3. Specifically, in the example shown in FIG. 2, the rectifier transistor Q2 is a diode, and the cathode of the opto-coupler diode D2 is coupled to the distribution control module 310 to receive the first error regulation signal, and the anode of the opto-coupler diode D2 is coupled to the output node of the first power distribution unit 210 through the resistor R3. In the example shown in FIG. 3, the rectifier transistor Q2 is a synchronous rectifier switching transistor, and the anode of the opto-coupler diode D2 is coupled to the distribution control module 310 to receive the first error regulation signal, and the cathode of the opto-coupler diode D2 is coupled to the reference ground through the resistor R3. In addition, when the rectifier transistor Q2 is a synchronous rectifier switching transistor, the current zero-crossing points of the first power distribution unit 210 and the second power distribution unit 220 can also be obtained through the control signal Vgs2 of the synchronous rectifier switching transistor.

The second error amplification unit 312 is used to perform error amplification on the feedback signal VFB2 of the output voltage of the second power distribution unit 220 and the second reference voltage signal Vo2_ref, or to perform error amplification on the feedback signal IFB2 of the output current of the second power distribution unit 220 and the second reference current signal Io2_ref, to generate the second error regulation signal, and generate the first conduction time indication signal based on the second error regulation signal.

Further, in the multi-output switching power supply provided by the embodiment of the present disclosure, a resistor R1 is also provided between the output terminal of the first power distribution unit 210 and a corresponding first output terminal 400, and a resistor R2 is provided between the output terminal of the second power distribution unit 220 and a corresponding second output terminal 500. The distribution control module 310 can obtain the feedback signal VFB1 of the output voltage and the feedback signal IFB1 of the output current of the first power distribution unit 210 by sampling the voltage signal across the resistor R1, and can obtain the feedback signal VFB2 of the output voltage and the feedback signal IFB2 of the output current of the second power distribution unit 220 by sampling the voltage signal across the resistor R2.

The modulation unit 313 is coupled to the second error amplification unit 312, and is used to sample the output terminal voltage Vdrain of the power conversion module 100 to detect the turn-on and turn-off moments of the main power transistor Q1 in the power conversion module 100, and generate plurality of distribution signals (comprising generating distribution signals Vgs11, Vgs12, Vgs13 and Vgs14) based on the detection results and the first conduction time indication signal.

The access detection unit 314 is used to detect the connection status of load devices at the plurality of output terminals, and indicate that the output mode is a multi-output mode when at least two output terminals are detected to have load devices connected, and indicate that the output mode is a single-output mode when one output terminal is detected to have a load device connected.

Further, the multi-output switching power supply provided by the embodiment of the present disclosure also comprises: a switch connection path is provided between the output terminal of each power distribution unit and the corresponding load connection terminal, and is turned on when a load device is connected to the corresponding output terminal . For example, a transistor Q3 is provided between the output terminal of the first power distribution unit 210 and the corresponding first output terminal 400, and a transistor Q4 is provided between the output terminal of each second power distribution unit 220 and the corresponding second output terminal 500. The transistor Q3 is coupled in series between the resistor R1 and the first output terminal 400, and the transistor Q4 is coupled in series between the resistor R2 and the second output terminal 500. The control terminals of the transistors Q3 and Q4 are both coupled to the access detection unit 314, and are configured to be turned on when a load device is connected to the corresponding output terminal, thereby conducting the output path.

In a further embodiment, the access detection unit 314 is also used to determine the charging protocol applicable to the output terminal based on the charging information fed back by the load device when a load device is connected to the output terminal. On this basis, the distribution control module 310 is also used to control the power distribution of the output power of the power conversion module 100 among the plurality of output terminals according to the charging protocol determined by the access detection unit 314, so that the voltage and current allocated to each output path can meet the charging protocol.

In some specific embodiments, the multi-output switching power supply also comprises a voltage overshoot protection unit 340, as shown in FIGS. 2 and 3. The voltage overshoot protection unit 340 is coupled to the output terminal (node A) of the power conversion module 100, and is used to absorb the energy at the connection node A during the startup process of the multi-output switching power supply, so as to control the first output signal output by the power conversion module 100 within a preset range and prevent voltage overshoot at the connection node A during the startup process.

In the example shown in FIG. 2 or FIG. 3, the voltage overshoot protection unit 340 specifically comprises: a diode D1 and a capacitor C3. The anode of the diode D1 is coupled to node A, and the cathode is coupled to the reference ground through the first capacitor C3. The supply voltage VCC required for the operation of the distribution control module 310 is also generated at the connection node of the diode D1 and the capacitor C3.

Further, the multi-output switching power supply also provides an output capacitor for each output path, comprising a capacitor C1 coupled between the output terminal of the first power distribution unit 210 and the reference ground, and a capacitor C2 coupled between the output terminal of the second power distribution unit 220 and the reference ground.

Referring to FIGS. 2, 3 and 4, the distribution control module 310 comprises: a power supply pin VCC, voltage sampling pins VD1, VD2, VD3, VD4, Vdrain, voltage detection pins VIN1, VIN2, current detection pins CSP1, CSN1, CSP2, CSN2, an opto-isolation pin OPTO, control pins Vgs11, Vgs12, Vgs13, Vgs14, Vgs3 and Vgs4.

The power supply pin VCC receives the supply voltage VCC; the voltage sampling pin VD1 is coupled to the drain of the transistor Q11 to sample the first voltage VD1 at the drain of the transistor Q11; the voltage sampling pin VD2 is coupled to the drain of the transistor Q12 to sample the second voltage VD2 at the drain of the transistor Q12; the voltage sampling pin VD3 is coupled to the drain of the transistor Q13 to sample the third voltage VD3 at the drain of the transistor Q13; the voltage sampling pin VD4 is coupled to the drain of the transistor Q14 to sample the fourth voltage VD4 at the drain of the transistor Q14; the voltage sampling pin Vdrain is coupled to the secondary winding Ns to sample the output terminal voltage Vdrain of the power conversion module 100; the voltage detection pin VIN1 is coupled to the output terminal of the first power distribution unit 210 to sample the output voltage Vo1 of the first power distribution unit 210; the voltage detection pin VIN2 is coupled to the output terminal of the second power distribution unit 220 to sample the output voltage Vo2 of the second power distribution unit 220; the current detection pin CSP1 is coupled to the first end of the resistor R1, and the current detection pin CSN1 is coupled to the second end of the resistor R1 to sample the output current Io1 of the first power distribution unit 210; the current detection pin CSP2 is coupled to the first end of the resistor R2, and the current detection pin CSN2 is coupled to the second end of the resistor R2 to sample the output current Io2 of the second power distribution unit 220; the opto-isolation pin OPTO is coupled to the isolation device 320 to transmit the first error regulation signal to the drive control module 330 through the isolation device 320; the control pin Vgs11 is coupled to the control terminal of the transistor Q11 to send the distribution signal Vgs11 to the transistor Q11; the control pin Vgs12 is coupled to the control terminal of the transistor Q12 to send the distribution signal Vgs12 to the transistor Q12; the control pin Vgs13 is coupled to the control terminal of the transistor Q13 to send the distribution signal Vgs13 to the transistor Q13; the control pin Vgs14 is coupled to the control terminal of the transistor Q14 to send the distribution signal Vgs14 to the transistor Q14; the control pin Vgs3 is coupled to the control terminal of the transistor Q3 to send the control signal Vgs3 to the transistor Q3; the control pin Vgs4 is coupled to the control terminal of the transistor Q4 to send the control signal Vgs4 to the transistor Q4.

In this embodiment, the distribution control module 310 is configured to turn on the first transistor (transistor Q11) in the second power distribution unit 220 during the period when the main power transistor Q1 is turned on; to turn off the first transistor (transistor Q13) in the first power distribution unit 210 after the first transistor in the second power distribution unit 220 has been turned on for the overlapping conduction time (denoted as Tg1_on_delay); to turn on the first transistor (transistor Q13) in the first power distribution unit 210 after a first time following the turn-off of the main power transistor Q1; and to turn off the first transistor (transistor Q11) in the second power distribution unit 220 after a second time following the turn-off of the main power transistor Q1. The second time is greater than the first time, thereby achieving alternate conduction control of the transistors Q11 and Q13.

The distribution control module 310 is further configured to adopt different control strategies for turning on and off the transistors in the plurality of power distribution units within different ranges of the first conduction time ton indicated by the conduction time indication signal, so as to ensure an optimal power distribution strategy for the output power of the power conversion module 100.

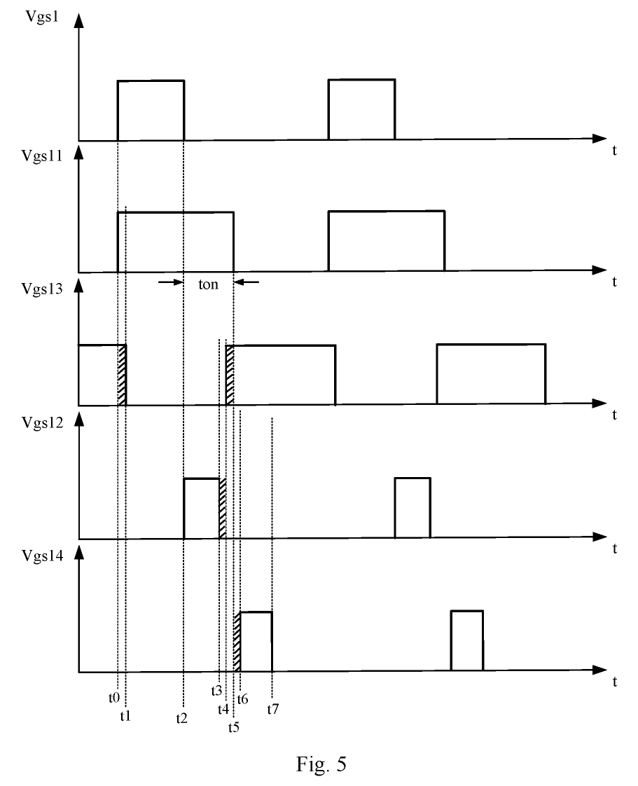

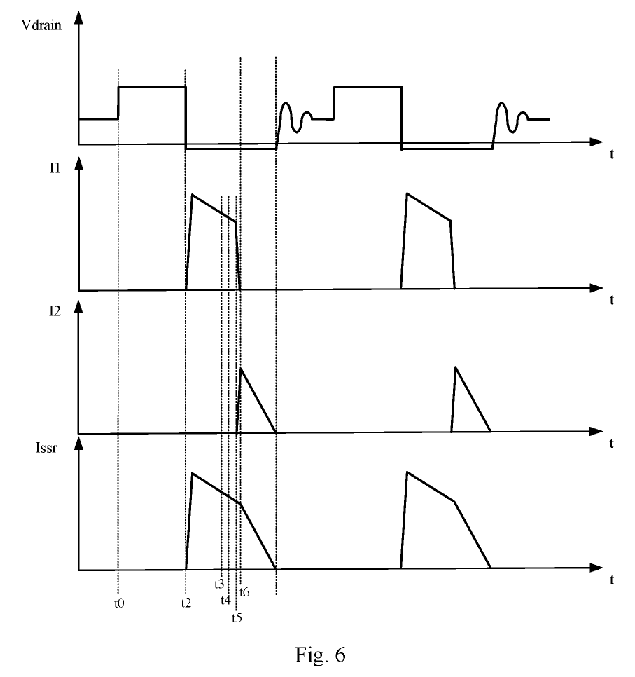

Referring to FIGS. 5 and 6, taking the plurality of power distribution units comprising the first power distribution unit 210 and the second power distribution unit 220 as an example, the control strategies of the distribution control module 310 within different ranges of the first conduction time ton comprise:

In the case where the first conduction time ton is greater than a preset first time threshold (for example, equal to the sum of a preset minimum conduction time threshold (denoted as Ton_min) and a preset dead time Tdeath) and less than a preset second time threshold (for example, equal to a preset maximum conduction time threshold (denoted as Ton_max)), that is, Ton_min + Tdeath < ton < Ton_max, after the main power transistor Q1 is turned off and before the transistor Q11 is turned off, the transistor Q12 is controlled to be turned on for a third time, and after the transistor Q11 is turned off and before the transistor Q13 is turned off, the transistor Q14 is controlled to be turned on for a fourth time. At this time, the aforementioned first time is equal to the first conduction time ton minus the overlapping conduction time Tg3_on_delay, that is, the first time is equal to ton - Tg3_on_delay; the second time is equal to the first conduction time ton; the third time is equal to the first conduction time ton minus the overlapping conduction time Tg3_on_delay and then minus the dead time Tdeath, that is, the third time is equal to ton - Tg3_on_delay - Tdeath; the fourth time is equal to the time length between the turn-off moment of the transistor Q11 and the first moment minus the dead time Tdeath, and the first moment represents the moment when the drain voltage of the transistor Q14 is greater than the drain voltage of the transistor Q13, that is, the first moment represents the moment when the third voltage VD3 is less than the fourth voltage VD4.

In the case where the first conduction time ton is greater than or equal to the preset second time threshold, that is, ton ≥ Ton_max, after the main power transistor Q1 is turned off and before the transistor Q11 is turned off, the transistor Q12 is controlled to be turned on for a third time, and the transistor Q14 is controlled to be continuously turned off. At this time, the aforementioned first time is equal to the sum of the third time and the dead time Tdeath; the second time is equal to the sum of the third time, the dead time Tdeath and the overlapping conduction time Tg3_on_delay; the third time is equal to the time length between the turn-off moment of the main power transistor Q1 and the second moment, and the second moment represents the moment when the drain voltage of the transistor Q12 is greater than the drain voltage of the transistor Q11, that is, the second moment represents the moment when the first voltage VD1 is less than the second voltage VD2.

In the case where the first conduction time ton indicated by the conduction time indication signal is less than or equal to the preset first time threshold, that is, ton ≤ Ton_min + Tdeath, the transistor Q12 is controlled to be continuously turned off, and after the transistor Q11 is turned off and before the transistor Q13 is turned off, the transistor Q14 is controlled to be turned on for a fourth time. At this time, the aforementioned first time is equal to zero; the second time is equal to the overlapping conduction time Tg3_on_delay; the fourth time is equal to the time length between the turn-off moment of the transistor Q11 and the first moment minus the dead time Tdeath, and the first moment represents the moment when the drain voltage of the transistor Q14 is greater than the drain voltage of the transistor Q13, that is, the first moment represents the moment when the third voltage VD3 is less than the fourth voltage VD4.

It should be noted that the aforementioned overlapping conduction times Tg1_on_delay and Tg3_on_delay may be the same time value or different time values. The alternate conduction mentioned in this document means that the turn-on and/or turn-off actions of the two are alternately performed, and does not mean that one is turned on after the other is turned off.

In some specific implementations, referring to FIGS. 2-6, when Ton_min + Tdeath < ton < Ton_max, the distribution control module 310 is configured to:

Within the time period (i.e., t0-t2) when the turn-on moment of the main power transistor Q1 is detected and the turn-off moment of the main power transistor Q1 has not yet been detected, output an effective (e.g., high-level) distribution signal Vgs11 to the second power distribution unit 220 to control the transistor Q11 to be turned on. Preferably, in order to ensure the accuracy and simplicity of control, the transistor Q11 can be controlled to be turned on at the moment t0 when the turn-on moment of the main power transistor Q1 is detected;

After the overlapping conduction time Tg1_on_delay of the transistor Q11, such as at moment t1, output an ineffective (e.g., low-level) distribution signal Vgs13 to the first power distribution unit 210 to control the transistor Q13 to be turned off;

Start timing after the turn-off moment (i.e., moment t2) of the main power transistor Q1 is detected, and at the same time, output an effective distribution signal Vgs12 to the second power distribution unit 220 to control the transistor Q12 to be turned on;

After the timing value reaches the difference (i.e., ton - Tdeath - Tg3_on_delay) between the first conduction time ton and the dead time Tdeath and the first overlapping conduction time Tg3_on_delay, such as at moment t3, output an ineffective distribution signal Vgs12 to the second power distribution unit 220 to control the transistor Q12 to be turned off;

After the timing value reaches the difference (i.e., ton - Tg3_on_delay) between the first conduction time ton and the first overlapping conduction time Tg3_on_delay, such as at moment t4, output an effective distribution signal Vgs13 to the first power distribution unit 210 to control the transistor Q13 to be turned on;

After the timing value reaches the first conduction time ton, such as at moment t5, output an ineffective distribution signal Vgs11 to the second power distribution unit 220 to control the transistor Q11 to be turned off;

After the dead time Tdeath following the turn-off of the transistor Q11, such as at moment t6, output an effective distribution signal Vgs14 to the first power distribution unit 210 to control the transistor Q14 to be turned on;

After the difference between the third voltage VD3 and the fourth voltage VD4 is detected to be less than zero, such as at moment t7, output an ineffective distribution signal Vgs14 to the first power distribution unit 210 to control the transistor Q14 to be turned off.

In some specific implementations, when ton ≥ Ton_max, the modulation unit 313 is configured to:

Within the time period (i.e., t0-t2) when the turn-on moment of the main power transistor Q1 is detected and the turn-off moment of the main power transistor Q1 has not yet been detected, output an effective (e.g., high-level) distribution signal Vgs11 to the second power distribution unit 220 to control the transistor Q11 to be turned on. Preferably, in order to ensure the accuracy and simplicity of control, the transistor Q11 can be controlled to be turned on at the moment t0 when the turn-on moment of the main power transistor Q1 is detected;

After the overlapping conduction time Tg1_on_delay of the transistor Q11, such as at moment t1, output an ineffective (e.g., low-level) distribution signal Vgs13 to the first power distribution unit 210 to control the transistor Q13 to be turned off;

Start timing after the turn-off moment (i.e., moment t2) of the main power transistor is detected, and at the same time, output an effective distribution signal Vgs12 to the second power distribution unit 220 to control the transistor Q12 to be turned on;

After the difference between the first voltage VD1 and the second voltage VD2 is detected to be less than zero, output an ineffective distribution signal Vgs12 to the second power distribution unit 220 to control the transistor Q12 to be turned off;

After the dead time Tdeath following the turn-off of the transistor Q12, output an effective distribution signal Vgs13 to the first power distribution unit 210 to control the transistor Q13 to be turned on;

After the first overlapping conduction time Tg3_on_delay of the transistor Q13, output an ineffective distribution signal Vgs11 to the second power distribution unit 220 to control the transistor Q11 to be turned off.

In some specific implementations, when ton ≤ Ton_min + Tdeath, the modulation unit 313 is configured to:

Within the time period (i.e., t0-t2) when the turn-on moment of the main power transistor Q1 is detected and the turn-off moment of the main power transistor Q1 has not yet been detected, output an effective (e.g., high-level) distribution signal Vgs11 to the second power distribution unit 220 to control the transistor Q11 to be turned on. Preferably, in order to ensure the accuracy and simplicity of control, the transistor Q11 can be controlled to be turned on at the moment t0 when the turn-on moment of the main power transistor Q1 is detected;

After the overlapping conduction time Tg1_on_delay of the transistor Q11, such as at moment t1, output an ineffective (e.g., low-level) distribution signal Vgs13 to the first power distribution unit 210 to control the transistor Q13 to be turned off;

Start timing after the turn-off moment (i.e., moment t2) of the main power transistor is detected, and at the same time, output an effective distribution signal Vgs13 to the first power distribution unit 210 to control the transistor Q13 to be turned on;

After the first overlapping conduction time Tg3_on_delay of the transistor Q13, output an ineffective distribution signal Vgs11 to the second power distribution unit 220 to control the transistor Q11 to be turned off;

After the dead time Tdeath following the turn-off of the transistor Q11, output an effective distribution signal Vgs14 to the first power distribution unit 210 to control the transistor Q14 to be turned on;

After the difference between the third voltage VD3 and the fourth voltage VD4 is detected to be less than zero, such as at moment t6, output an ineffective distribution signal Vgs14 to the first power distribution unit 210 to control the transistor Q14 to be turned off.

Further, when the multi-output switching power supply has three output terminals, that is, the plurality of power distribution units in the multi-output switching power supply comprise the first power distribution unit, the second power distribution unit and the third power distribution unit corresponding to the three output terminals respectively, similarly taking the first transistor and the second transistor in each power distribution unit as switching transistors as an example, at this time, the distribution control module 310 in the control circuit 300 is configured to generate a first error regulation signal based on the feedback of the output signal of the first power distribution unit and transmit it to the drive control module 330, and the drive control module 330 generates the drive signal based on the first error regulation signal to control the switching state of the main power transistor Q1 in the power conversion module 100; and the distribution control module 310 is also used to generate a second error regulation signal based on the feedback of the output signal of the second power distribution unit, generate a third error regulation signal based on the feedback of the output signal of the third power distribution unit, and generate three distribution signals based on the second error regulation signal and the third error regulation signal to control the switching states of the transistors in the first power distribution unit, the second power distribution unit and the third power distribution unit respectively. The first conduction time indication signal is used to indicate the expected conduction time of the first transistor in the second power distribution unit after the main power transistor Q1 is turned off, the second conduction time indication signal represents the expected conduction time of the first transistor in the third power distribution unit in the current control cycle, the turn-on indication signal of the main power transistor represents the turn-on moment of the main power transistor Q1, and the turn-off indication signal of the main power transistor represents the turn-off moment of the main power transistor Q1.

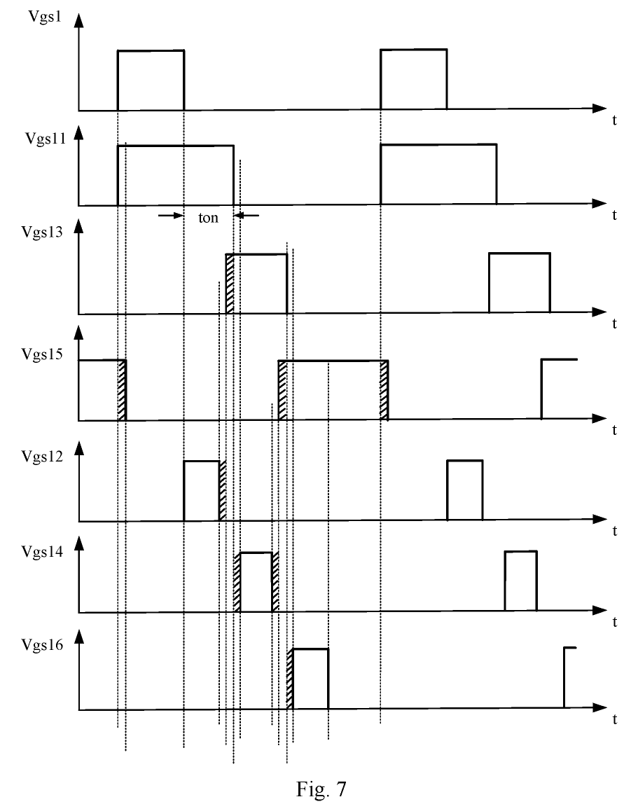

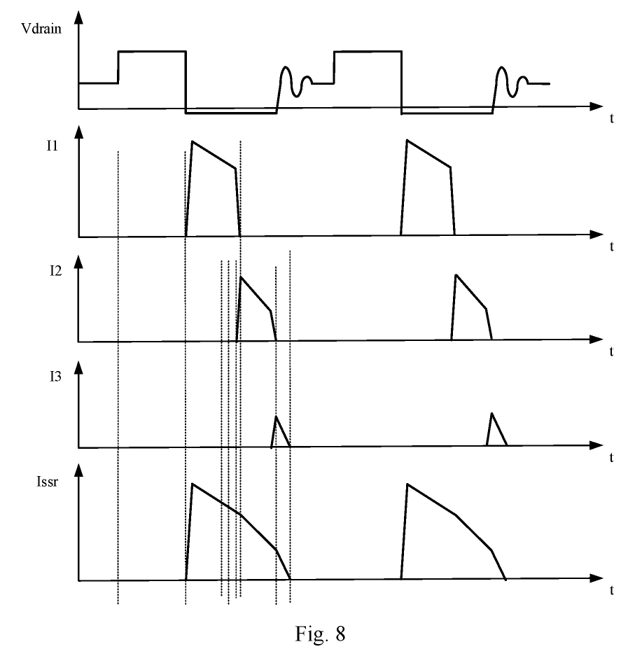

For a multi-output switching power supply with three outputs, referring to FIGS. 7 and 8, wherein the distribution signals Vgs15 and Vgs16 correspond to the control signals of the first transistor and the second transistor in the third power distribution unit (not shown), respectively, and the current I3 corresponds to the output current waveform of the third power distribution unit (not shown). The working principle of the multi-output switching power supply with three outputs can be obtained by simple expansion of the multi-output switching power supply with two outputs.

Those skilled in the art can understand that, inspired by the embodiments of the present disclosure, multi-output power supplies can also be of four, five or more outputs, and the control ideas that are the same as or analogous to those of the present invention are all within the protection scope of the present invention.

It can be understood that, on the one hand, the scheme of the present disclosure optimizes the structure of the multi-output switching power supply, comprising setting a power distribution unit comprising a first transistor and a second transistor connected back-to-back (such as the back-to-back connected transistors Q1 and Q2, and the back-to-back connected transistors Q3 and Q4) on each output path in the multi-output mode of the multi-output switching power supply, to perform power distribution among the plurality of output terminals;

On the other hand, the scheme of the present disclosure also optimizes the control scheme of the multi-output switching power supply. By feeding back the voltage and/or current of the first power distribution unit 210, and performing error operation and amplification to output a drive opto-coupler, the total power output by the primary side is controlled. By feeding back the voltage and/or current of the second power distribution unit 220, and performing error operation and amplification to obtain the first conduction time ton of the first transistor (transistor Q1) in the second power distribution unit 220, the turn-on and turn-off of each transistor (such as Q1-Q4) in each power distribution unit are controlled based on the first conduction time ton, the preset overlapping conduction time Tg_on_delay and dead time Tdeath, and the detection of the drain voltages of the transistors, and different control strategies are executed within different ranges of the first conduction time ton, so as to control the distribution of energy among the plurality of output terminals.

Compared with the existing schemes, the scheme of the present disclosure can eliminate the need for inductor components or multiple sets of AC/DC circuits during the power distribution process, and the turn-off loss of each transistor is smaller, the efficiency is higher, the heat generation is less, and the cost is lower. At the same time, the use of two transistors connected back-to-back for power distribution enables the output terminal to achieve a larger power output, thereby greatly improving the charging efficiency during multi-port charging and having stronger adaptability.

Further, the embodiment of the present disclosure also provides a charger, which comprises the multi-output switching power supply disclosed in any of the foregoing embodiments, and can achieve the same technical effects.

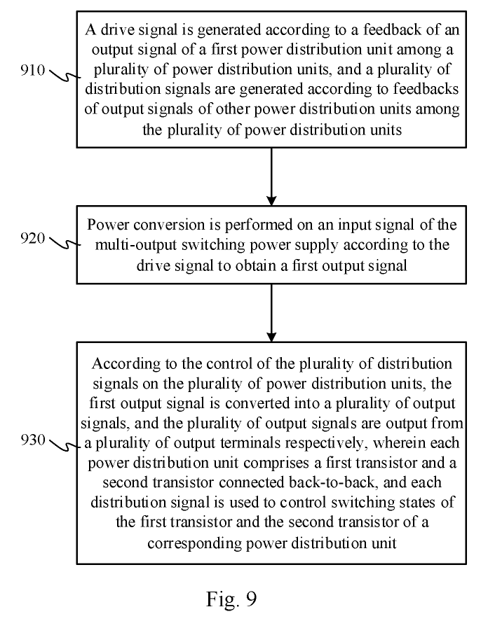

Further, the embodiment of the present disclosure also provides a charging control method for a multi-output switching power supply, which can be applied to the multi-output switching power supply disclosed in any of the foregoing embodiments. Specifically, referring to FIG. 9, the charging control method comprises the following steps:

In step 910, a drive signal is generated according to feedback of an output signal of a first power distribution unit among a plurality of power distribution units, and a plurality of distribution signals are generated according to feedback of output signals of other power distribution units among the plurality of power distribution units.

In step 920, power conversion is performed on an input signal of the multi-output switching power supply according to the drive signal to obtain a first output signal.

In step 930, according to the control of the plurality of distribution signals on the plurality of power distribution units, the first output signal is converted into a plurality of output signals, and the plurality of output signals are output from a plurality of output terminals respectively, wherein each power distribution unit comprises a first transistor and a second transistor connected back-to-back, and each distribution signal is used to control switching states of the first transistor and the second transistor of a corresponding power distribution unit.

In specific implementation, the specific implementation of each step in the above-described charging control method for the multi-output switching power supply and the corresponding technical effects that can be achieved can be referred to the foregoing embodiments of the multi-output switching power supply, and will not be described in detail here.

Finally, it should be noted that: obviously, the above embodiments are only examples for clearly illustrating the present disclosure, and are not intended to limit the implementation manners. For those of ordinary skill in the art, changes or modifications in other different forms can also be made on the basis of the above description. It is unnecessary and impossible to list all the implementation manners here. However, obvious changes or modifications derived from the above description are still within the protection scope of the present disclosure.

What is claimed is:

1. A multi-output switching power supply, comprising:
a power conversion module, configured to perform power conversion on an input signal of the multi-output switching power supply according to a drive signal to obtain a first output signal;
a plurality of power distribution units, coupled between an output terminal of the power conversion module and a plurality of output terminals of the multi-output switching power supply, respectively, and configured to convert the first output signal into a plurality of output signals according to a plurality of distribution signals, the plurality of output signals being output from the plurality of output terminals respectively; and
a control circuit, configured to generate the drive signal according to feedback of an output signal of a first power distribution unit among the plurality of power distribution units, and generate the plurality of distribution signals according to feedback of output signals of other power distribution units among the plurality of power distribution units,
wherein each of power distribution units comprises a first transistor and a second transistor connected back-to-back, and each of the distribution signals is configured to control switching states of the first transistor and the second transistor of a corresponding power distribution unit.

2. The multi-output switching power supply of claim 1, wherein the first transistor and the second transistor are low-voltage transistors.

3. The multi-output switching power supply of claim 2, wherein the first transistor and the second transistor are switching transistors;
a cathode of a body diode of the first transistor is coupled to the output terminal of the power conversion module, and a cathode of a body diode of the second transistor is coupled to a corresponding output terminal of the plurality of output terminals;
the distribution signals of each of the power distribution units comprises a first distribution signal and a second distribution signal, a control terminal of the first transistor receives the first distribution signal , and a control terminal of the second transistor receives the second distribution signal .

4. The multi-output switching power supply of claim 2, wherein the first transistor is a switching transistor, and the second transistor is a diode;
a cathode of a body diode of the first transistor is coupled to the output terminal of the power conversion module, an anode of the diode is coupled to an anode of the body diode of the first transistor, and a cathode of the diode is coupled to a corresponding output terminal of the plurality of output terminals;
a control terminal of the first transistor receives the distribution signal of the corresponding power distribution unit.

5. The multi-output switching power supply of claim 3, wherein the plurality of distribution signals are configured to:
control the first transistor of each of the power distribution units to be turned on alternately; and
control the second transistor of each of the power distribution units to be turned on or to be continuously turned off during a period when the first transistor of the corresponding power distribution unit is turned on;
wherein a magnitude of an output signal of each of the power distribution units is positively correlated with a turn-on duration of the first transistor of the power distribution unit.

6. The multi-output switching power supply of claim 4, wherein the plurality of distribution signals are further configured to:
control the first transistor of each of the power distribution units to be turned on alternately;
wherein a magnitude of an output signal of each of the power distribution units is positively correlated with a turn-on duration of the first transistor of the power distribution unit.

7. The multi-output switching power supply of claim 5, wherein a dead time is between the conducting first transistor of each of the power distribution unit and the adjacent conducting second transistor of a next power distribution unit.

8. The multi-output switching power supply of claim 7, wherein an overlapping conduction time is between two adjacent conducting first transistors of the two power distribution units.

9. The multi-output switching power supply of claim 8, wherein
the plurality of power distribution units comprise the first power distribution unit and a second power distribution unit;
the control circuit comprises a distribution control module and a drive control module;
the distribution control module is configured to generate a first error regulation signal according to feedback of an output signal of the first power distribution unit and transmit the first error regulation signal to the drive control module, and the drive control module is configured to generate the drive signal according to the first error regulation signal to control a switching state of a main power transistor of the power conversion module;
the distribution control module is further configured to generate a second error regulation signal according to feedback of an output signal of the second power distribution unit, generate a first conduction time indication signal according to the second error regulation signal, and perform a logic operation on the first conduction time indication signal, a turn-on indication signal of the main power transistor, and a turn-off indication signal of the main power transistor to generate the plurality of distribution signals to control switching states of transistors of the plurality of power distribution units;
the first conduction time indication signal is configured to indicate that an expected turn-on time of the first transistor of the second power distribution unit after turn-off of the main power transistor is a first conduction time, and a magnitude of the first conduction time is controlled according to the second error regulation signal.

10. The multi-output switching power supply of claim 9, wherein the distribution control module is configured to:
turn on the first transistor of the second power distribution unit during a period when the main power transistor is turned on;
turn off the first transistor of the first power distribution unit after the first transistor of the second power distribution unit is turned on for the overlapping conduction time;
turn on the first transistor of the first power distribution unit after a first time following turn-off of the main power transistor; and
turn off the first transistor of the second power distribution unit after a second time following turn-off of the main power transistor,
wherein the second time is greater than the first time.

11. The multi-output switching power supply of claim 10, wherein, in a case of the first conduction time being greater than a preset first time threshold and less than a preset second time threshold, the distribution control module is further configured to:
turn on the second transistor of the second power distribution unit for a third time after turn-off of the main power transistor and before turn-off of the first transistor of the second power distribution unit; and
turn on the second transistor of the first power distribution unit for a fourth time after turn-off of the first transistor of the second power distribution unit and before turn-off of the first transistor of the first power distribution unit,
wherein the first time threshold is equal to a sum of a preset minimum conduction time threshold and a dead time, and the second time threshold is a preset maximum conduction time threshold.

12. The multi-output switching power supply of claim 10, wherein, in a case of the first conduction time being greater than or equal to a preset second time threshold, the distribution control module is further configured to:
turn on the second transistor of the second power distribution unit for a third time after turn-off of the main power transistor and before turn-off of the first transistor of the second power distribution unit; and
control the second transistor of the first power distribution unit to be continuously turned off,
wherein the second time threshold is a preset maximum conduction time threshold.

13. The multi-output switching power supply of claim 10, wherein, in a case of the first conduction time being less than or equal to the preset first time threshold, the distribution control module is further configured to:
control the second transistor of the second power distribution unit to be continuously turned off; and
turn on the second transistor of the first power distribution unit for a fourth time after turn-off of the first transistor of the second power distribution unit and before turn-off of the first transistor of the first power distribution unit,
wherein the first time threshold is equal to a sum of a preset minimum conduction time threshold and a dead time.

14. The multi-output switching power supply of claim 8, wherein
the plurality of power distribution units comprise the first power distribution unit, a second power distribution unit, and a third power distribution unit;
the control circuit comprises a distribution control module and a drive control module;
the distribution control module is configured to generate a first error regulation signal according to feedback of an output signal of the first power distribution unit and transmit the first error regulation signal to the drive control module, and the drive control module is configured to generate the drive signal according to the first error regulation signal to control a switching state of a main power transistor of the power conversion module;
the distribution control module is further configured to generate a second error regulation signal according to feedback of an output signal of the second power distribution unit, generate a third error regulation signal according to feedback of an output signal of the third power distribution unit, and generate three distribution signals according to the second error regulation signal and the third error regulation signal to control switching states of transistors of the first power distribution unit, the second power distribution unit, and the third power distribution unit respectively.

15. The multi-output switching power supply of claim 1, further comprising:
a voltage overshoot protection unit coupled to the output terminal of the power conversion module and configured to control the first output signal within a preset range during startup of the multi-output switching power supply.

16. The multi-output switching power supply of claim 1, further comprising:
a switch connection path between an output terminal of each power distribution unit and a corresponding load connection terminal, and configured to be turned on when a load device is connected to the corresponding output terminal.

17. The multi-output switching power supply of claim 1, wherein the power conversion module comprises a main power transistor, a rectifier transistor, and a transformer;
the main power transistor is connected to a primary winding of the transformer, the rectifier transistor is connected to a secondary winding of the transformer, and a voltage on the secondary winding of the transformer is rectified by the rectifier transistor to obtain the first output signal;
the main power transistor and the rectifier transistor are high-voltage transistors.

18. The multi-output switching power supply of claim 17, wherein the rectifier transistor is connected between the secondary winding and a ground terminal.

19. A control method for a multi-output switching power supply, the multi-output switching power supply comprising a plurality of power distribution units, the control method comprising:
generating a drive signal according to feedback of an output signal of a first power distribution unit among the plurality of power distribution units, and generating a plurality of distribution signals according to feedback of output signals of other power distribution units among the plurality of power distribution units;
performing power conversion on an input signal of the multi-output switching power supply according to the drive signal to obtain a first output signal; and
converting the first output signal into a plurality of output signals according to the plurality of distribution signals controlling the plurality of power distribution units,
wherein each of power distribution units comprises a first transistor and a second transistor connected back-to-back, and each of distribution signals is configured to control switching states of the first transistor and the second transistor of a corresponding power distribution unit.
